(19) United States
(12) Patent Application Publication
(10) Pub. No.: US 2025/0191380 A1
(43) Pub. Date: Jun. 12, 2025

(54) METHOD OF AND DEVICE FOR IDENTIFYING ROAD DISTRESS ON A ROAD BASED ON IMAGERY OF THE ROAD

(71) Applicant: FNV IP B.V., Leidschendam (NL)

(72) Inventors: Marcus NEPVEAUX, Lafayette, LA (US); Matthew CONNELLY-TAYLOR, Mississauga (CA); Andrea ANNOVI, Vancouver (CA); Manpreet MINHAS, Toronto (CA); Liam BUI, Vancouver (CA)

(21) Appl. No.: 18/536,754

(22) Filed: Dec. 12, 2023

(51) Int. Cl. G06V 20/56; G01B 11/30; G06T 5/80; G06T 7/12; G06V 10/25; G06V 10/44; G06V 10/764

(52) U.S. Cl. CPC G06V 20/588; G01B 11/30; G06T 5/80; G06T 7/12; G06V 10/25; G06V 10/44; G06V 10/764; G06T 2207/30256

(57) ABSTRACT

A method of identifying road distress on a road based on imagery of the road is disclosed. The method is performed by a processor and comprises the steps of: identifying a region of interest from road regions detected in the imagery of the road; detecting one or more road distresses present in the region of interest by identifying features associated with physical characteristics related to road distress in an original image comprising the region of interest; detecting one or more road distresses present in the region of interest by identifying features associated with physical characteristics related to road distress in a corrected image obtained by applying at least one of optical distortion correction and perspective distortion correction to the original image comprising the region of interest; and identifying one or more road distresses by combining the detection based on the original image and the detection based on the corrected image. Unlocking insights from Geo-Data, the present invention further relates to improvements in sustainability and environmental developments: together we create a safe and liveable world.

### FIELD OF THE INVENTION

The present disclosure generally relates to the technical field of road maintenance, more particularly, to a method of identifying road distress on a road based on imagery of the road and a device performing the method. Unlocking insights from Geo-Data, the present invention further relates to improvements in sustainability and environmental developments: together we create a safe and liveable world.

### BACKGROUND OF THE INVENTION

Pavement distress or road distress is used to describe any type of irregular wear, damage, or deterioration that occurs on road pavements, and it encompasses various specific distress types, including cracks, potholes, rutting, spalling, and others.

Detecting and classifying “pavement distress anomalies” like cracks and potholes is important to maintain road safety and efficiency. These anomalies can signal larger-scale roadway deterioration, posing safety risks to vehicles and potentially causing accidents. Additionally, early detection aids in prioritizing and scheduling repair tasks, leading to cost-effective maintenance planning. With advanced classification, specific types of anomalies can be identified and associated with certain causes or future pavement behaviour, enabling pre-emptive measures. Thus, this process contributes to safer, smoother, and more efficient roadways, improving the overall transportation infrastructure.

Traditional methods of identifying pavement distress anomalies have relied on human observation and analysis, which can be subjective and prone to errors. The varying methods used by different individuals can result in inconsistent interpretations and outcomes. Additionally, manual analysis is time-consuming and may not be sustainable for clients with limited budgets.

Other methods involve employment of more advanced devices and technologies including LiDAR and 3D Imaging, Unmanned Aerial Vehicles, UAVs, or drones, or satellite or aerial imagery, which are costly and therefore not readily available for entities with limited budgets.

Vehicles are currently mostly equipped with cameras which can capture images of the road while driving. Such images are readily available, without the need of extra hardware which might be costly.

In consideration of the above, it is desirable there is a method of identifying road distress on a road in a cost effective and accurate way, based on imagery of the road.

### BRIEF SUMMARY OF THE INVENTION

According to one aspect of the present disclosure, there is presented a method of identifying road distress on a road based on imagery of the road, the method performed by a processor and comprising the steps of:
identifying a region of interest from road regions detected in the imagery of the road, wherein the region of interest comprises possible road distress(es);
detecting one or more road distresses present in the region of interest by identifying features associated with physical characteristics related to road distress in an original image comprising the region of interest;
detecting one or more road distresses present in the region of interest by identifying features associated with physical characteristics related to road distress in a corrected image obtained by applying at least one of optical distortion correction and perspective distortion correction to the original image comprising the region of interest; and
identifying one or more road distresses by combining the detection based on the original image and the detection based on the corrected image.

The present disclosure is based on the insight of the inventors that road distress identification in an identified region of interest, based on imagery of the road, can be more reliably and accurately performed, when the image corrected with optical and/or perspective distortion that is present in the image is taken into consideration. The corrected image is used in addition to the original image containing the region of the interest.

According to the method of the present disclosure, when a region of interest, that is, a region comprising possible road distresses, is identified, one or more road distress present in the region of interested is identified in the original image comprising the region of interest.

Moreover, a corrected image is obtained from the original image by applying optical distortion correction and/or perspective distortion correction to the original image. Road distresses present in the corrected image are also identified. A final identification result comprising road distresses in the region of interest is obtained by combining the road distresses detected based on both the original image and the corrected image.

By using both the original and the corrected images in the road distress identification, a number of detections and a filtering algorithm can be improved as it is important to have a reliable and unique numbers of distresses per image.

In an example of the present disclosure, the method further comprises the following step prior to the identifying step:
determining road regions in the imagery of the road by categorizing different features, present in an image, related to different objects into different classes.

It will be understood by those skilled in the art that different features related to different physical objects, such as roads, buildings, trees and so on are present in an image. For the present disclosure, the road regions, which are the object or target under study, are determined by categorizing the different features into classes.

In an example of the present disclosure, the determining step is performed by a first machine learning module separating and categorizing the features present in the image using semantic segmentation.

The primary goal of Semantic Segmentation is to categorize and assign each pixel within an image to a specific class or object, generating a dense pixel-wise segmentation map, which allows the road regions to be determined from the image.

In an example of the present disclosure, the method further comprises the following step subsequent to the determining step:
identifying a road lane on the determined road regions by considering at least one of lane lines, curb features, and half of a full pavement width.

Identifying road lanes or roadway lane detection is used to distinguishing between different roadway lanes. This allows subsequent road distress identification to be performed with reference to separated lanes, which helps to facilitate the road distress identification.

In an example of the present disclosure, the identifying step is performed by a second machine learning module trained with lane data for identifying road lanes.

It can be contemplated by those skilled in the art that lane detection or identification can be performed using well-trained machine learning modules, which will help to improve the overall efficiency of the road distress identification procedure.

In an example of the present disclosure, the step of identifying a region of interest is performed further based on historical imagery data of the region of interest.

For images of the road taken with a forward-looking camera mounted on a vehicle, the region of interest is a specific rectangle area in front of the camera which takes motion of the vehicle and historical data of images into consideration The historical data of images is used to control how much of the region of interest is duplicated from previous views of the road, for example seconds earlier. This is implemented to prevent overlapping areas between different images, which helps to keep the distress identification more efficient.

In an example of the present disclosure, the physical characteristics related to road distress comprises one or more of a pothole, an alligator cracks, a longitudinal crack, and a transverse crack.

Those are the commonly seen distresses present on roads, which can be conveniently identified using the method of the present disclosure.

In an example of the present disclosure, features associated with physical characteristics related to road distress comprises crack width or crack length.

As can be contemplated by those skilled in the art, distresses are evaluated in terms of for example width and length related to a crack or depth of a pothole. These features are used to identify the distress.

It will be understood by those skilled in the art that an orientation calculation is also performed to properly categorize a crack as either longitudinal or transverse. The orientation is computed relative to the lane direction. For example, a crack orientation of 0 degrees describes a longitudinal crack. Likewise, 90 degrees describes a transverse crack.

Crack orientation is required for crack classification of longitudinal and transverse cracks. Similarly, a density or pattern identification would be required to classify alligator cracking.

In an example of the present disclosure, the steps of detecting one or more distresses in the original image and in the corrected image are performed by a third machine learning module identifying features associated with physical characteristics related to road distress.

The machine learning module may rely on training dataset annotations associated with crack width and crack length to perform distress identification. The machine model tuning can influence the accuracy and efficiency of detection. For example, if the training dataset annotated all visible cracks, no matter the size, then very small cracks can be detected.

In an example of the present disclosure, the method further comprises a step of identifying wheels path of a vehicle capturing the imagery of the road.

The identification of wheel paths of the vehicle helps to give precise rating to the identified distresses.

In an example of the present disclosure, the method further comprises a step of assigning a rating to the one or more identified distresses.

A rating or ranking assigned to each identified distress can be conveniently used to decide any restoration or repair that is necessary to maintain the road in good condition.

In an example of the present disclosure, the imagery of the road is obtained via a forward looking camera mounted on a vehicle.

This is a very cost effective way of obtaining the imagery used in the method of the present disclosure, which does not require more complicated and expensive hardware such as LiDAR camera or laser devices.

In an example of the present disclosure, the imagery is captured at a fixed interval.

Having a constant time interval between consecutive images captured using the camera allows the captured images to be processed following a set time order, it ensures that the road surfaces are examined and studied with little overlapping while guaranteeing that no road regions are skipped.

In a second aspect of the present disclosure, there is presented a device for identifying road distress on a road based on imagery of the road, the device comprising a processor for performing the method according to the first aspect of the present disclosure.

In a third aspect of the present disclosure, there is presented a computer program product comprising a computer readable storage medium storing instructions which, when executed on at least one processor, cause the at least one processor to carry out the method according to the first aspect of the present disclosure.

The above mentioned and other features and advantages of the disclosure will be best understood from the following description referring to the attached drawings. In the drawings, like reference numerals denote identical parts or parts performing an identical or comparable function or operation.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are therefore not to be considered to be limiting of its scope, the principles herein are described and explained with additional specificity and detail through the use of the accompanying drawings in which:

FIG. 1 schematically illustrates, in a flow chart type diagram, an embodiment of a method of identifying road distress on a road based on imagery of the road in accordance with the present disclosure.

FIG. 2 illustrates an exemplary image used to train the CNN model.

FIG. 3 illustrates a result obtained after the categorization is performed, in which a grey area is identified as road.

FIG. 4 illustrates a lane between detected according to the method of the present disclosure.

FIG. 5 illustrates a region of interest as identified following the method of the present disclosure.

FIG. 6 illustrates a bird's eye view of the region of interest shown in FIG. 5, which is also referred to as the warped image.

FIG. 7 illustrates an image which may be used to train the machine learning module for detection distresses on the road.

FIG. 8 illustrates distress detected from the image as shown in FIG. 5

FIG. 9 schematically illustrates distresses detected in the corrected image of FIG. 6, and

FIG. 10 schematically illustrates the identified distresses.

### DESCRIPTION OF ILLUSTRATIVE EMBODIMENTS

Embodiments contemplated by the present disclosure will now be described in more detail with reference to the accompanying drawings. The disclosed subject matter should not be construed as limited to only the embodiments set forth herein. Rather, the illustrated embodiments are provided by way of example to convey the scope of the subject matter to those skilled in the art.

The present disclosure offers a cost-effective solution for pavement condition assessment, making it accessible to clients with small or remote road networks. Its unique balance between affordability and high-quality data collection addresses the limitations of both low-resolution and expensive high-resolution systems. Consequently, it enables a more comprehensive understanding of road conditions, contributing to enhanced road safety and drivability.

The method and system of the present disclosure identifies lanes of a roadway using automatic region detection based on semantic segmentation in the imagery of the road. The system then employs advanced machine vision algorithms to detect and classify pavement distress anomalies such as cracks and potholes.

Each anomaly is graded based on type and spatial attributes such as width, length, density, etc. Distress rating of a given section of pavement is inferred by considering all anomalies in a section along with density, spatial relationships, and types thereof.

While the initial analysis is performed image-by-image, the motion of the vehicle and subsequent repetition of features in the images can be taken into account to aid the accuracy of the overall solution. This data can be aggregated by section, lane, and roadway to provide pavement condition summary reports.

The system uses low resolution pavement condition rating using images obtained from forward-looking camera images mounted on data collection vehicles (Right-of-Way, ROW, camera).

The system then uses at least one machine learning algorithm to generate a rating for the objects identified in the road. As a result, the system could provide a highly portable acquisition and rating system using less advanced sensors but more advanced processing.

The present disclosure is a combination of a hardware camera that acquire images and a software part which is a combination of several algorithms that accurately identify distresses on the road assigning a predefined rating.

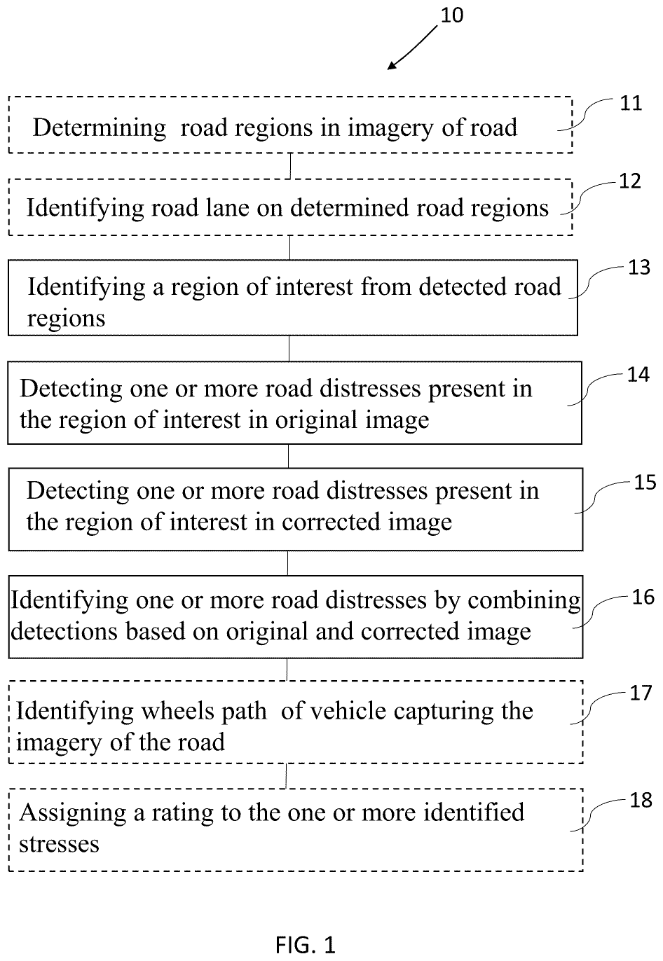

FIG. 1 schematically illustrates, in a flow chart type diagram, an embodiment of a method of identifying road distress on a road based on imagery of the road in accordance with the present disclosure.

As a preparation step, images of a road to examine or study is obtained. This can be performed via a forward-looking camera mounted on a vehicle. The images of the road are captured at a fixed interval.

As can be contemplated by those skilled in the art, images of roads captured using other devices may also be processed using the method of the present disclosure to identify road distresses, as long as resolution of the images allows such features to be identified.

At step 11, road regions in the imagery of the road are determined by categorizing different features, present in an image, related to different objects into different classes.

This is realised by semantic segmentation which classifies every single region on the captured image using a machine learning algorithm which will separate the images into different areas, such as road, vegetation, cars, buildings and so on.

“Semantic Segmentation”, in the context of the present invention, is a subdomain of computer vision technology, used for the automatic region detection in for example vehicle-mounted camera imagery. The primary goal of Semantic Segmentation is to categorize and assign each pixel within an image to a specific class or object, generating a dense pixel-wise segmentation map. This labelling technique facilitates (in the next steps) distinguishing between different roadway lanes and features, thereby forming the foundation for the anomaly or road distress detection process.

Convolutional neural networks are widely used for precise region identification within images due to their ability to automatically learn hierarchical features. It functions to label regions or segments of an image in accordance with their visual content, providing a pixel-level classification map for the input image. This method also allows identifying and delineating regions of pavement distress like cracks and potholes within each captured image.

The integration of Semantic Segmentation, combined with advanced machine vision algorithms, allows for an automated and highly accurate analysis of roadway pavement conditions. It is noted that segmentation is also trained. Regions of an image are annotated, and the machine learning model learns these regions given the variety of examples in the training dataset.

Other machine learning algorithm may also be used, such as a transfer learning model, a support vector machine and so on.

In an example of using CNN to identify road regions, a diverse set of images including different roads that represent the variability of conditions is used to train the CNN model. Each image in the training dataset is annotated with correct class labels such as “road” or “vegetation”. Care has to be taken to ensure that annotations are accurate and consistent.

A large amount of labelled images is used to train the CNN model such that meaningful features can be learned. Besides, it is ensured that a number of images in each class of feature is balanced.

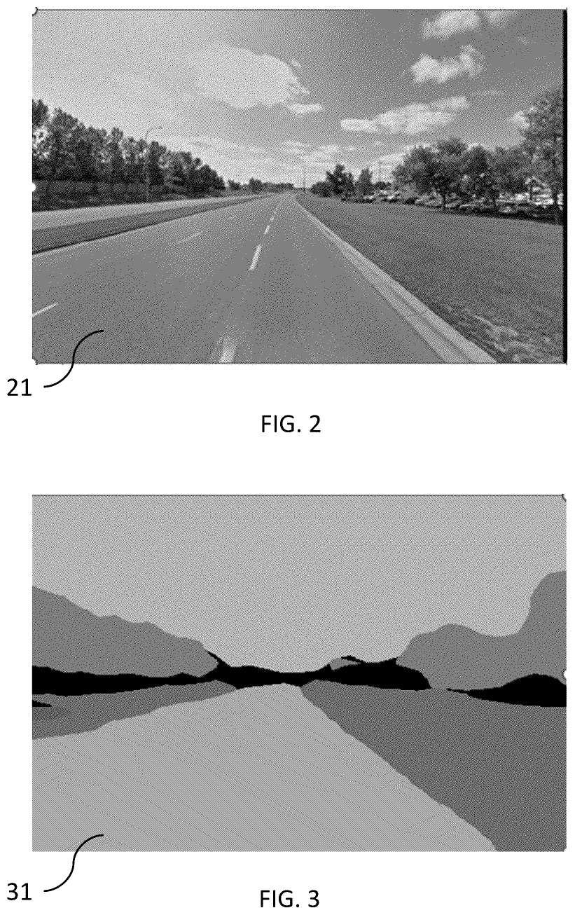

FIG. 2 illustrates an exemplary image used to train the CNN model. In this image, road 21 and vegetations are present. FIG. 3 illustrates a result obtained after the categorization is performed, in which a grey area marked by numeral 31 is identified as road.

At an optional step 12, one or more road lanes on the determined road regions are identified.

This can be done by executing roadway lane detections using machine learning. An algorithm that is used comprises a pre-trained module for detecting lanes based on various factors and markers such as lane lines, curbs and so on. The roadway lane detection is the distinguishing between different roadway lanes and features referred to above.

The machine learning module for lane detection comprises a dataset used to build models for lane detection and models built with lane detection data.

In one example, the machine learning module relies on lane lines to detect lanes. When lane lines are visible, left and right boundaries of a region of interest may be used. In another example, detecting curb features may be used by the machine learning module. In still another example, a method of detecting the full pavement width and taking only half is used, when there are no lane markings.

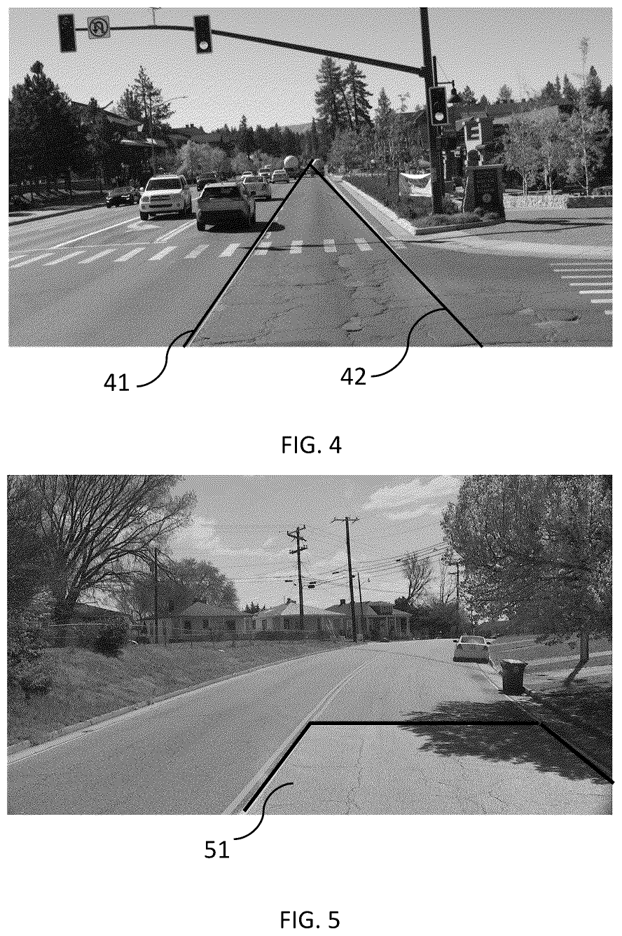

FIG. 4 illustrates a lane between lines 41 and 42 detected according to the method of the present disclosure.

It can be contemplated by those skilled in the art that where a road has a single lane, step 12 can be omitted.

At step 13, a region of interest from road regions detected in the imagery of the road is identified. The region of interest comprises possible road distress(es).

This involves an offline process which operates on a sequence of raw images and “distance stamp”, which is used to identify a region of interest, ROI, of each image.

Wherein lane detection is necessary, once the road and the lanes are identified, a ROI, identification is performed. This region is a specific rectangle area in front of the camera which takes the motion of the vehicle and the historical data of a predefined buffer of images into consideration. The predefined buffer is used to control how much of the ROI is duplicated from previous views of the road (seconds earlier). As the vehicle drives forward, the same section of pavement will be visible within different rows of the image. The buffer images thus reduce double ROI identification.

The images are captured at a fixed interval; therefore, an algorithm is implemented to prevent overlapping areas between different images. In case the road doesn't contain lanes, historical images are used to compute the rectangle and to identify the ROI area in front of the camera where road distresses are to be identified and rated.

Using the identified ROI, the image is projected into a flat plane “bird's eye view” using the parallel lanes of the road. As can be contemplated by those skilled in the art, geometric transformations are used to simulate the perspective as if the image was captured from above.

The part of the original image comprising the region of interest is processed by applying at least one of optical distortion correction and perspective distortion correction to obtain a corrected image part.

In an example, source points corresponding to corners of the ROI in the original image are defined. Then these points are adjusted based on the perspective of the road image. It further defines destination points to map the source points to. This defines the rectangle in the bird's-eye view. Next, the perspective transformation matrix is compared based on the source and destination points. By applying the perspective transform to the original image using the computed matrix the eye-bird-view image is obtained.

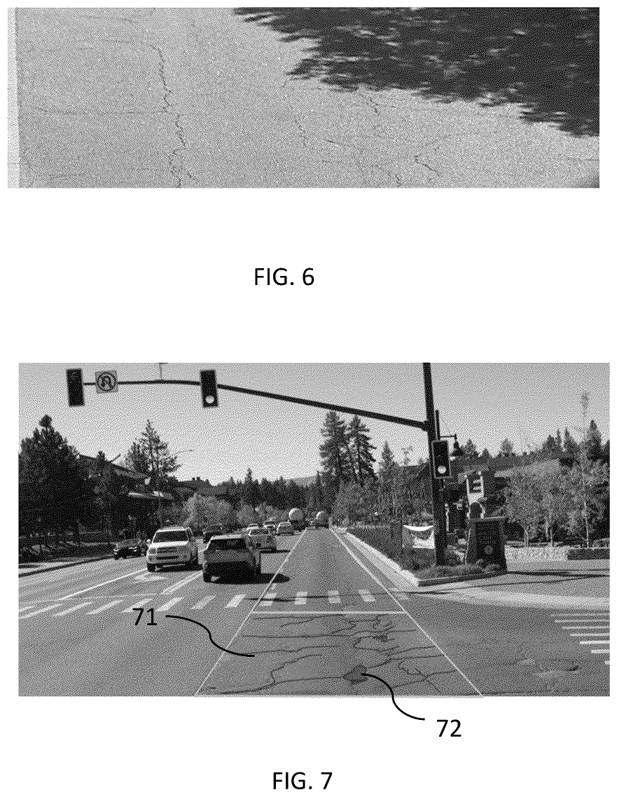

FIG. 5 illustrates an ROI 51 as identified following the method of the present disclosure. FIG. 6 illustrates an eye-bird viewing of the ROI shown in FIG. 5, which is also referred to as the warped image.

At step 14, one or more road distresses present in the region of interest is detected by identifying features associated with physical characteristics related to road distress in an original image comprising the region of interest.

In an example, an edge detection algorithm, such as the Canny edge detector, may be used to highlight edges of objects in the image. Stresses on the road often manifest as irregularities in the road surface, which can be detected through changes in pixel intensity.

An object detection algorithm identifies the presence of certain features (objects) within an image. It is not concerned with selection of individual pixels; only identifying a region within an image containing specific features.

Distress detection can be realised by running a Machine Learning object detection algorithm for identifying any distresses that are present on the pavement. Physical characteristics such as crack width, length, may be used in the distress identification. These specific physical characteristics of the features detected will directly depend on the training dataset annotations and the machine model tuning. For example, if the training dataset annotated all visible cracks, no matter the size, then that is what the model is intended to detect.

The crack identification is based on what the model learns during training stage and usually are physical attributes like edges, shapes and colors. The features like crack width are not explicit training input but could be learnt by the segmentation model. E.g. if training data has only wider cracks, then the model only detects/segments wider cracks.

In an example, four major classes of distresses are identified, that is, potholes, alligator cracks, longitudinal and transverse cracks. In this phase a deep learning object detection algorithm is used to identify the distresses in the road.

Training data for the machine learning module are annotated according to features that we are interested in. In one example, potholes and cracks were identified in the training data and a model using an object detection toolkit is trained based on the training data.

FIG. 7 illustrates an image which may be used to train the machine learning module for detection distresses on the road. In the image of FIG. 7, cracks 71 and pothole 72 are annotated, which is used to train the machine learning module to identify features of these distresses.

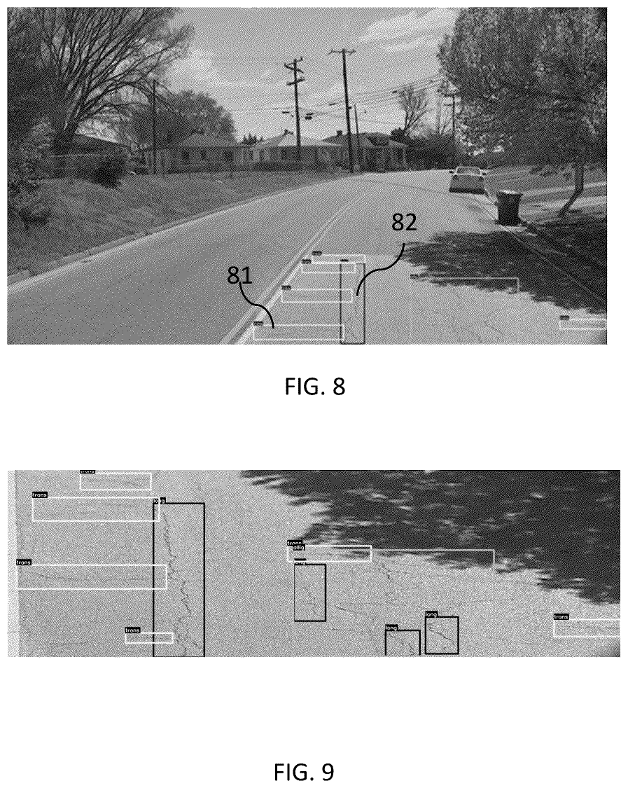

FIG. 8 illustrates distress detected from the image as shown in FIG. 5, in which transverse cracks as illustrated by light horizontal rectangular boxes 81 and longitudinal cracks as illustrated by dark vertical rectangular boxes 82 are identified.

It is noted that camera position information such as time and location of taking a picture of the road under study is used to georeference distress features.

At step 15, one or more road distresses present in the region of interest are detected by identifying features associated with physical characteristics related to road distress in a corrected image obtained by applying at least one of optical distortion correction and perspective distortion correction to the original image comprising the region of interest.

This can be done as a separate step than step 14 or in parallel to step 14. In a sense, the input images to the machine learning algorithm for detecting distresses are the natively warped projected images and the original images.

Raw images collected from a camera are not normally orthogonally co-registered with the world. Camera pointing angle, camera perspective, and lens distortion will all be present in a raw image. Natively warped projected images are images that are warped to remove optical distortions.

As there is no camera intrinsic/extrinsic parameters, perspective correction maybe simply performed by transforming the trapezoidal ROI into a rectangle ROI.

Further using image transformation-based warped image can improve overall accuracy during training. Projected/transformed images are also used to compute actual dimensions of the distress.

FIG. 9 illustrates distress detected from the warped image as shown in FIG. 6, in which transverse cracks as illustrated by light horizontal rectangular boxes 91 and longitudinal cracks as illustrated by dark vertical rectangular boxes 92 are identified. It is seen that more longitudinal cracks are identified based on the warped image.

At step 16, one or more road distresses by combining the detection based on the original image and the detection based on the corrected image are identified.

We use both images to improve the number of detections and filtering algorithm because it is important to have a reliable and unique numbers of distresses per image.

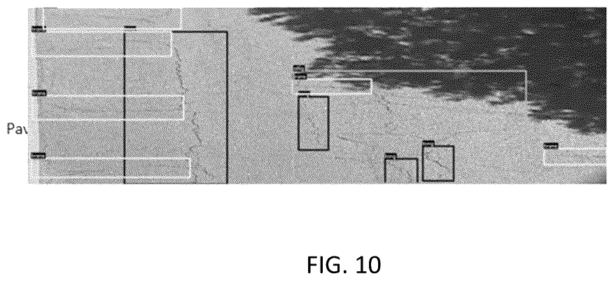

The final identification result of FIG. 10 is obtained by combining FIGS. 8 and 9.

At step 17, wheels path of a vehicle capturing the imagery of the road are identified.

An exemplary method for obtaining wheels path is as follows: There are two zones measured from a centerline of the lane: the inside wheel path (left of the centerline) and the outside wheel path (right of the centerline). Each are about 0.875 meter (35 inches) from the centerline. The numbers are for illustrative purpose only and is not limitative to the present disclosure.

Before assigning the rating to the road segment we identify the wheels path of the vehicle in the captured image because it is needed to assign a reliable rating to the pavement.

At step 18, a rating is assigned to the one or more identified distresses.

The step consists of assigning a rating based on a predefined rating scheme that will rely on the distresses detected on the pavement in the previous pipeline step. An exemplary schema may consist of 5 different levels, and it is based on the number of cracks and potholes with respect to the analysed pavement surface.

This present disclosure can run using as input images captured with any in any types of cameras that allows geo-referencing. This means any camera that has a known (surveyed) pointing angle, registered to a platform (vehicle) location and orientation, and with appropriate lens distortion correction, can be used.

It has been tested with images captured at a fix distance interval, but it will be suitable also for a device that capture images at a time-base interval. It can run on any embodiments such as a mobile device with integrated cameras including GPU processing, or a vehicle equipped with a fix mounted camera such as GigE camera mounted on an autonomous vehicle.

The invention has been described by reference to certain embodiments discussed above. It will be recognized that these embodiments are susceptible to various modifications and alternative forms well known to those of skill in the art.

Further modifications in addition to those described above may be made to the structures and techniques described herein without departing from the spirit and scope of the invention. Accordingly, although specific embodiments have been described, these are examples only and are not limiting upon the scope of the invention.

1. A method of identifying road distress on a road based on imagery of the road, the method comprising:
identifying a region of interest from road regions detected in the imagery of the road, wherein the region of interest includes possible road distresses;
detecting at least a first possible road distress present in the region of interest by identifying features associated with physical characteristics related to road distress in an original image including the region of interest;
detecting at least a second possible road distress present in the region of interest by identifying features associated with physical characteristics related to road distress in a corrected image obtained by applying at least one of optical distortion correction and perspective distortion correction to the original image including the region of interest; and
identifying one or more road distresses by combining the at least first possible road distress and the at least second possible road distress.

2. The method according to claim 1, further comprising:
determining road regions in the imagery of the road by categorizing different features, present in an image, related to different objects into different classes.

3. The method according to claim 2, wherein the determining is performed by a first machine learning module separating and categorizing the features present in the image using semantic segmentation.

4. The method according to claim 2, further comprising:
identifying a road lane on the determined road regions by considering at least one of lane lines, curb features, and half of a full pavement width.

5. The method according to claim 4, wherein the identifying is performed by a second machine learning module trained with lane data for identifying road lanes.

6. The method according to claim 1, wherein the identifying the region of interest is performed further based on historical imagery data of the region of interest.

7. The method according to claim 1, wherein the physical characteristics related to road distress comprises one or more of a pothole, an alligator cracks, a longitudinal crack, and a transverse crack.

8. The method according to claim 1, wherein features associated with physical characteristics related to road distress comprises crack width or crack length.

9. The method according to claim 1, wherein the detecting one or more distresses in the original image and in the corrected image are performed by a third machine learning module identifying features associated with physical characteristics related to road distress.

10. The method according to claim 1, further comprising identifying wheels path of a vehicle capturing the imagery of the road.

11. The method according to claim 1, further comprising assigning a rating to the one or more identified distresses.

12. The method according to claim 1, wherein the imagery of the road is obtained via a forward looking camera mounted on a vehicle.

13. The method according to claim 12, wherein the imagery is captured at a fixed interval.

14. A device comprising:
a processor; and
a memory storing instructions, which when executed by the processor, causes the device to:
identify a region of interest from road regions detected in imagery of the road, wherein the region of interest includes possible road distresses;
detect at least a first possible road distress present in the region of interest by identifying features associated with physical characteristics related to road distress in an original image including the region of interest;
detect at least a second possible road distress present in the region of interest by identifying features associated with physical characteristics related to road distress in a corrected image obtained by applying at least one of optical distortion correction and perspective distortion correction to the original image including the region of interest; and
identify one or more road distresses by combining the at least first possible road distress and the at least second possible road distress.

15. A non-transitory computer readable storage medium storing instructions which, when executed on at least one processor, cause the at least one processor to:
identify a region of interest from road regions detected in imagery of the road, wherein the region of interest includes possible road distresses;
detect at least a first possible road distress present in the region of interest by identifying features associated with physical characteristics related to road distress in an original image including the region of interest;
detect at least a second possible road distress present in the region of interest by identifying features associated with physical characteristics related to road distress in a corrected image obtained by applying at least one of optical distortion correction and perspective distortion correction to the original image including the region of interest; and
identify one or more road distresses by combining the at least first possible road distress and the at least second possible road distress.

16. The device according to claim 14, further comprising instructions, which when executed by the processor, causes the processor to:
determine road regions in the imagery of the road by categorizing different features, present in an image, related to different objects into different classes.

17. The device according to claim 16, wherein the determining is performed by a first machine learning module configured to separate and categorize the features present in the image using semantic segmentation.

18. The device according to claim 16, further comprising instructions, which when executed by the processor, causes the processor to:
identify a road lane on the determined road regions by considering at least one of lane lines, curb features, and half of a full pavement width.

19. The device according to claim 18, wherein the identifying is performed by a second machine learning module trained with lane data configured to identify road lanes.

20. The device according to claim 14, wherein the identifying the region of interest is performed further based on historical imagery data of the region of interest.
